(19) United States
(12) Patent Application Publication
(10) Pub. No.: US 2024/0306556 A1
(43) Pub. Date: Sep. 19, 2024

(54) DEVICE AND METHOD FOR HYDRATING PLANT STEMS

(71) Applicant: VANTHUS TECHNOLOGIES, LLC, Sudbury, MA (US)

(72) Inventor: JUAN CARLOS VAN DIJK, Sudbury, MA (US)

(73) Assignee: VANTHUS TECHNOLOGIES, LLC, Sudbury, MA (US)

(21) Appl. No.: 18/674,986

(22) Filed: May 27, 2024

Related U.S. Application Data
(63) Continuation-in-part of application No. 17/889,610, filed on Aug. 17, 2022.
(60) Provisional application No. 63/523,183, filed on Jun. 26, 2023.

(51) Int. Cl. A01G 5/06; A47G 7/06

(52) U.S. Cl. CPC A01G 5/06; A47G 7/06

(57) ABSTRACT

A device for hydrating and supporting cut plants includes two or more sheets of flexible film material, shaped and sealed to each other on two opposite sides and a bottom side to form a water sleeve that is configured be filled with a hydrating liquid, leaving an open top side through which cut plants can be inserted. The device further includes two or more tie sections extending from the open top side of the two or more sheets of flexible film material, respectively. The two or more tie sections are configured to be wrapped around one or more stems of the inserted cut plants and knotted, thereby securing the plants, sealing the open top side of the water sleeve, and preventing leakage from the water sleeve.

### CROSS REFERENCE TO RELATED CO-PENDING APPLICATIONS

This application claims the benefit of U.S. provisional application Ser. No. 63/523,183 filed on Jun. 26, 2023 and entitled DEVICE AND METHOD FOR HYDRATING PLANT STEMS, which is commonly assigned and the contents of which are expressly incorporated herein by reference.

This application is a continuation-in-part and claims the benefit of U.S. application Ser. No. 17889610 filed on Aug. 17, 2022 and entitled FLORAL ARRANGEMENT MECHANICS AND METHODS, which is commonly assigned and the contents of which are expressly incorporated herein by reference.

### FIELD OF THE INVENTION

The present invention relates to a device and a method for hydrating plant stems, and more particularly, to a device for the hydration and support of plant stems during transportation, display or storage.

### BACKGROUND OF THE INVENTION

This invention relates to a device to feed cut plants during transportation or when displaying plants for sale, for ornamental purposes or floral arrangement competition, as is common in floristry. These applications include, but are not limited to, flower care and handling, floral design, flower arranging, merchandising, production, display and flower delivery. There is a need in those industries to prolong the life of the plant by placing its stem in a feeding medium, typically water that may be enriched with plant feeding additives. It is further desirable in the industry to have such transportation, storage or display device be sealed around the stem of the plants to prevent any spillage or loss of liquid by evaporation. It is further desirable in the present industry to have such devices be home compostable, such that plants can be disposed of after use with their hydrating devices still attached. There are several prior art containers and devices that are used for this purpose, however they suffer from varying disadvantages, namely that the containers in the prior art are bulky to store, are impractical to make home compostable, tend to leak, or are made from disparate materials making them hard to recycle. An example of prior art containers are plastic “water tubes” which are popularly used and come in different sizes. They are generally provided with elastomeric caps through which a plant stem can be inserted after water is poured in the tube. These “water tubes” are typically made from petrochemical based plastics, are typically not compostable and need to be separated from the plants for disposal. The tubes usually leak, and are bulky to store and transport. The tubes need independent support or attachment mechanisms so that they can be positioned upright without leaking or attached to other structures when desired. Accordingly, there is a need for devices and methods for hydrating plant stems that integrate production simplicity, low cost, home compostability, minimal storage footprint, ease of use, ease of installation and ease of disposal.

### SUMMARY OF THE INVENTION

The invention provides a device and a method for hydrating and supporting cut plants. One or more sheets of flexible film material are shaped and sealed on three sides to form a water sleeve, a pocket that can be filled with a liquid, leaving an open upper end through which cut plants can be inserted. Beyond the open upper end, the flexible material is extended to include two or more tie sections which can be wrapped around the stem of the inserted plants and knotted, thereby securing the plants, substantially sealing the open end of the pocket, and preventing leakage from the pouch, for example when the assembly is in a non-vertical orientation, during transport, display or storage. The remaining free ends of the sleeve can further serve to tie the pocket and plant assembly to other plants, to staging or to other floral mechanics as is commonly practiced in the industry. The water sleeve is further designed to be optionally supplied as a set of multiple units, such as in roll form, with perforated portions provided between the individual water sleeves.

In general, in one aspect the invention provides a device for hydrating and supporting cut plants including two or more sheets of flexible film material, shaped and sealed to each other on two opposite sides and a bottom side to form a water sleeve that is configured to be filled with a hydrating liquid, leaving an open top side through which cut plants can be inserted. The device further includes two or more tie sections extending from the open top side of the two or more sheets of flexible film material, respectively, and wherein the two or more tie sections are configured to be wrapped around one or more stems of the inserted cut plants and knotted, thereby securing the plants, sealing the open top side of the water sleeve, and preventing leakage from the water sleeve.

Implementations of this aspect of the invention may include one or more of the following. The remaining free ends of the two or more tie sections are shaped and dimensioned to tie the water sleeve to other plants, or floral mechanics, or vertical structures. The two or more sheets of flexible film material are sealable via heat. The two or more sheets of flexible film material comprise biodegradable, home compostable materials and are sustainably sourced. The two or more sheets of flexible film material comprise a Poly Lactic Acid (PLA) based polymer. Each of the two or more sheets of flexible film material comprises a film thickness in a range of 5 microns to 1 mm. The device further includes a growing medium or a structural support medium such as foam, coir, gel, or beads configured to be placed within the water sleeve.

In general, in another aspect the invention provides a set of water sleeves including a plurality of water sleeves connected to each other by vertically extending perforated portions. Each of the water sleeves includes two or more sheets of flexible film material, sealed to each other on two opposite sides and a bottom side, and further including an open top side through which a hydrating liquid and cut plants can be inserted into the water sleeve. Each of the water sleeves further includes two or more tie sections extending from the open top side of the two or more sheets of flexible film material, respectively, and wherein the two or more tie sections are configured to be wrapped around one or more stems of the inserted cut plants and knotted, thereby securing the plants, sealing the open top side of the water sleeve, and preventing leakage from the water sleeve. The set of water sleeves may form a roll of rolled up water sleeves.

In general, in another aspect the invention provides a method for hydrating and supporting cut plants including the following. Providing two or more sheets of flexible film material, sealing them to each other on two opposite sides and a bottom side to form a water sleeve, and leaving an open top side. Next, filling the water sleeve with hydrating liquid and inserting cut plants into the water sleeve through the open top side. Two or more tie sections extend from the open top side of the two or more sheets of flexible film material, respectively. The method further includes wrapping the two or more tie sections around one or more stems of the inserted cut plants and knotting them together, thereby securing the plants, sealing the open top side of the water sleeve, and preventing leakage from the water sleeve.

The details of one or more embodiments of the invention are set forth in the accompanying drawings and description below. Other features, objects, and advantages of the invention will be apparent from the following description of the preferred embodiments, the drawings and from the claims.

### BRIEF DESCRIPTION OF THE DRAWINGS

Referring to the figures, wherein like numerals represent like parts throughout the several views:

FIG. 1A depicts a water sleeve device according to this invention;

FIG. 1B depicts the water sleeve device of FIG. 1A with an inserted plant stem;

FIG. 1C is an exploded view of the water sleeve device of FIG. 1A;

FIG. 2A depicts the upper extensions of the water sleeve of FIG. 1A tied around the plant stem;

FIG. 2B shows a tightened knot around the plant stem so that the water sleeve fully envelops the stem and acts as a seal to keep any liquid from spilling out of the water sleeve;

FIG. 3 depicts the assembly of FIG. 2B being attached to a wire grate;

FIG. 4 depicts a roll form of the water sleeve devices of FIG. 1A, having a series of sleeves manufactured with pre-perforated cuts in between each sleeve to allow easy singulation prior to use;

FIG. 5 is an image of the roll form of the water sleeve of FIG. 4;

FIG. 6 is an image of the water sleeve device of FIG. 1A with an inserted plant stem; and

FIG. 7 is an image of the water sleeve device of FIG. 1A with an inserted plant stem tied to a door handle.

### DETAILED DESCRIPTION OF THE INVENTION

The present invention relates to a device and a method for a vessel or a water sleeve that holds water and can accommodate one or more stems of plants and tie them to the water sleeve for the purpose of keeping them hydrated during transport, display or storage. The invention provides several functions that are desirable in the floristry industry, such as enabling a very high volume and low cost production method, requiring very small volume storage, incorporating a way to tie the plant stems to the water sleeve, a way to seal the water sleeve to prevent leakage, and a way to further attach the assembly to other water sleeves, mechanics or staging. In some embodiments the invention also provides, a design that can be sustainably sourced, is home compostable and can be disposed of in an environmentally conscious manner, without the need to separate the container from the plants after use.

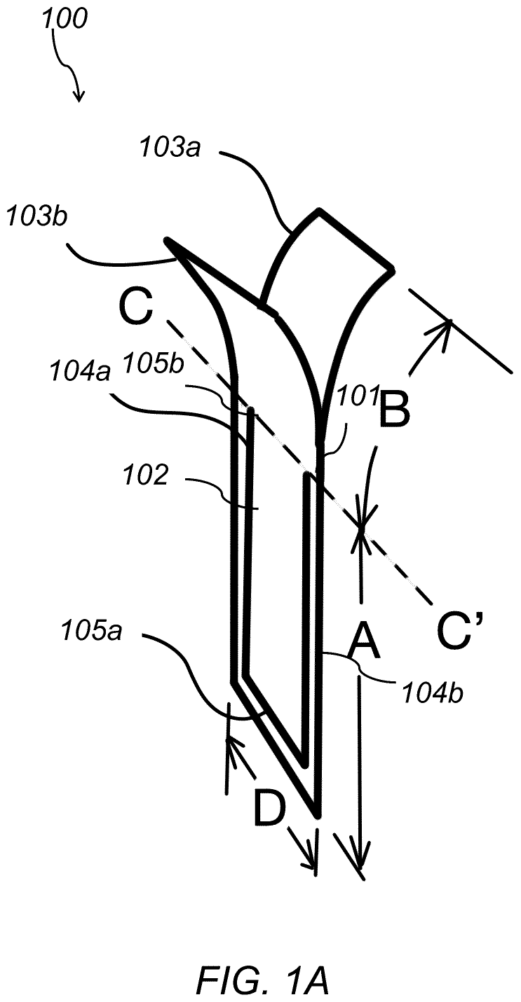

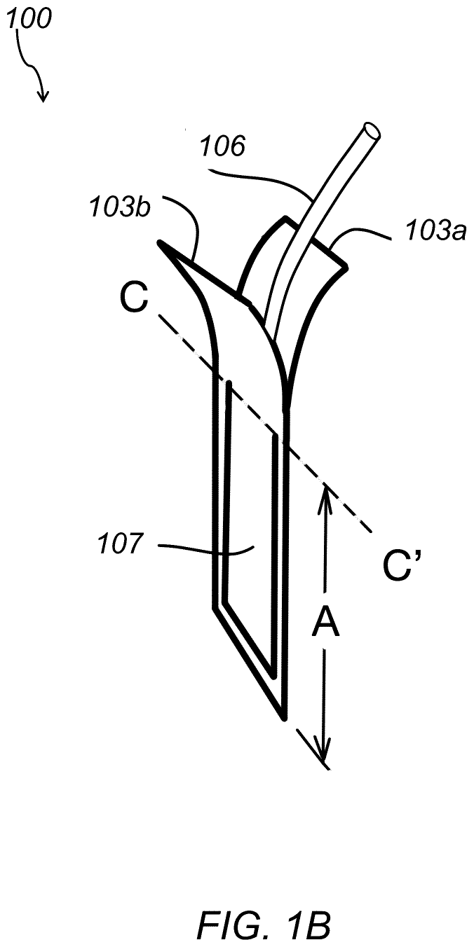

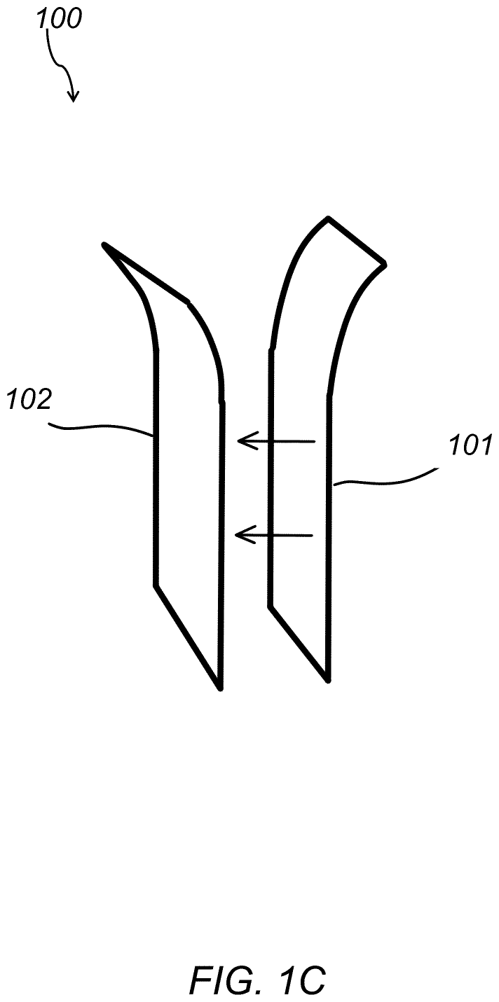

Referring to FIG. 1A-FIG. 1C, a water sleeve device 100 includes two film segments 101, 102, attached to each other on opposite sides 104a, 104b and the bottom side 105a of the lower portion “A” of the sleeve. The upper segment “B” of the water sleeve 100 includes two free and unattached sleeve ties 103a, 103b. Portion “A” of the sleeve 100 effectively forms a pocket 107 that can be filled with liquid, and has an opening at the top 105b along the line C-C′ through which a plant stem 106 can be inserted, as shown in FIG. 1B. In one embodiment of the invention the attachment of the sleeve segments 101, 102 in the lower portion “A” is achieved with a heat sealing apparatus. The water sleeves 100 can be supplied in several dimensions to correspond to any particular floristry application. Typically, the length for portion “A” is in the range from 1 cm to 45 cm, the length for portion “B” is in the range from 1 cm to 45 cm, which is long enough to comfortably form a knot, and the width for portion“D” is in the range from 1 cm to 20 cm. In one example, the length for A is 15 cm, the length for B is 18 cm, and the width for D is 4.5 cm.

In one embodiment, the water sleeve 100 is formed using two separate film segments 101, 102, as shown in FIG. 1C. In other embodiments, water sleeve 100 is formed by folding one segment of a film, or by starting with a tubular segment of film. In a preferred embodiment of the invention, the film that makes up the water sleeve 100 is made from a material that is biodegradable, home compostable and sustainably sourced. In one example, the water sleeve material is a Poly Lactic Acid (PLA) based polymer, which is a polyester produced by fermentation under controlled conditions of a carbohydrate source like corn starch or sugarcane. In order to favor home compostability the film thickness is usually around 25 microns. The practical range of film thickness for this invention is from 5 microns to 1 mm.

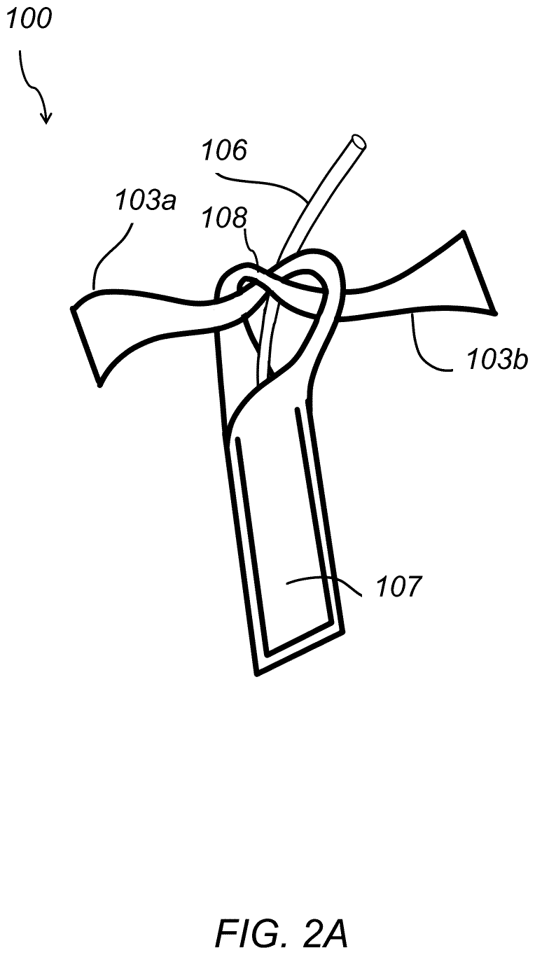

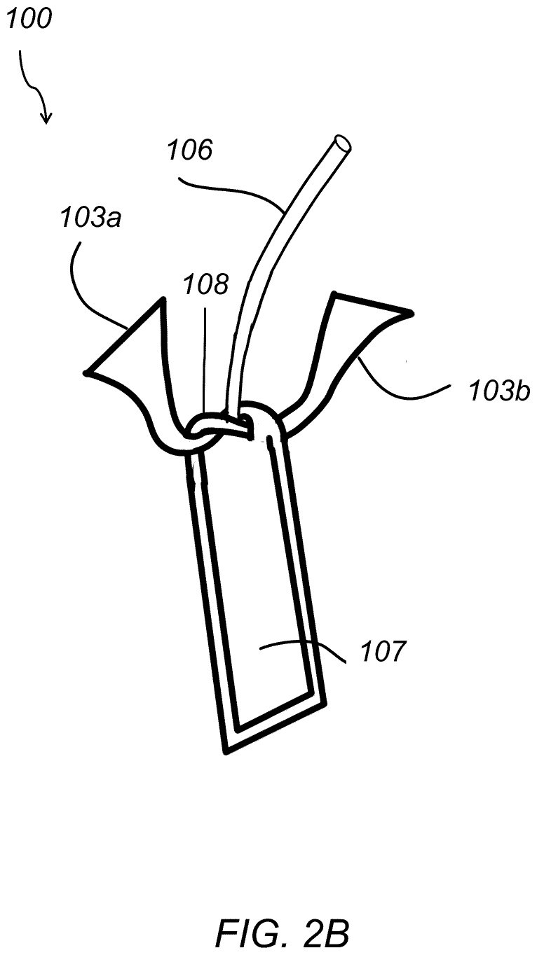

FIG. 2A and FIG. 2B depict the method that allows the plant stem 106 to be affixed to the sleeve thereby providing the beneficial effect of sealing the liquid inside the pouch 107. As shown in FIG. 2A, the sleeve ties 103a, 103b, on each of the sleeve segments 101, 102, are folded around the plant stem 106 and tied into a knot 108 so that they capture the plant stem 106 and effectively affix it to the sleeve 107. The knot 108 is further tightened to form a seal between the stem 106 and the sleeve 107 and substantially trap the liquid inside the sleeve 107, as shown in FIG. 2B. It will be experienced by the practicing florist that the seal can be further improved by tightly wrapping one or both ties around the stem at least once before completing the knot.

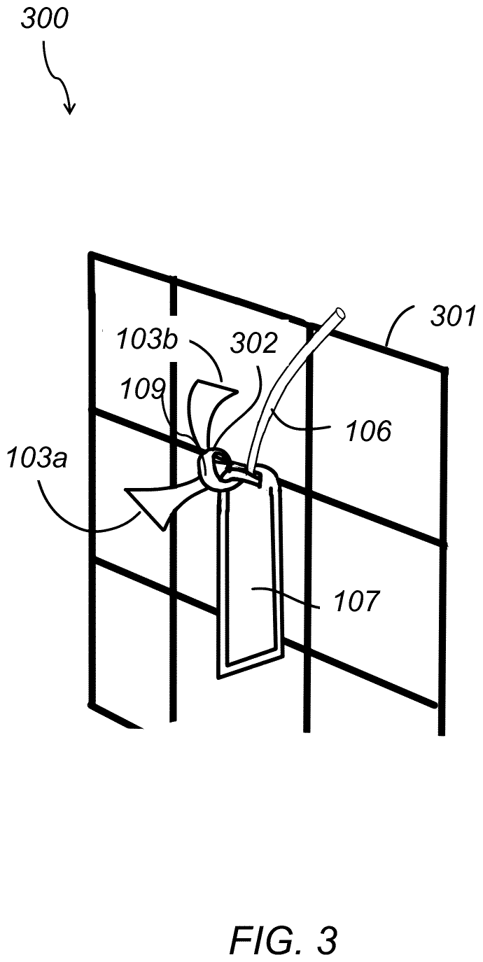

The sleeve 107 with the enclosed stem 106 can be further attached to a wire matrix structure 301 by making a second knot 109 at position 302 of the wire matrix structure using the remaining length of the ties 103a, 103b, as shown in FIG. 3. The sleeves 107 with plant stems 106 can thereby be attached to floral mechanics or to each other for the purposes of transport, display or storage.

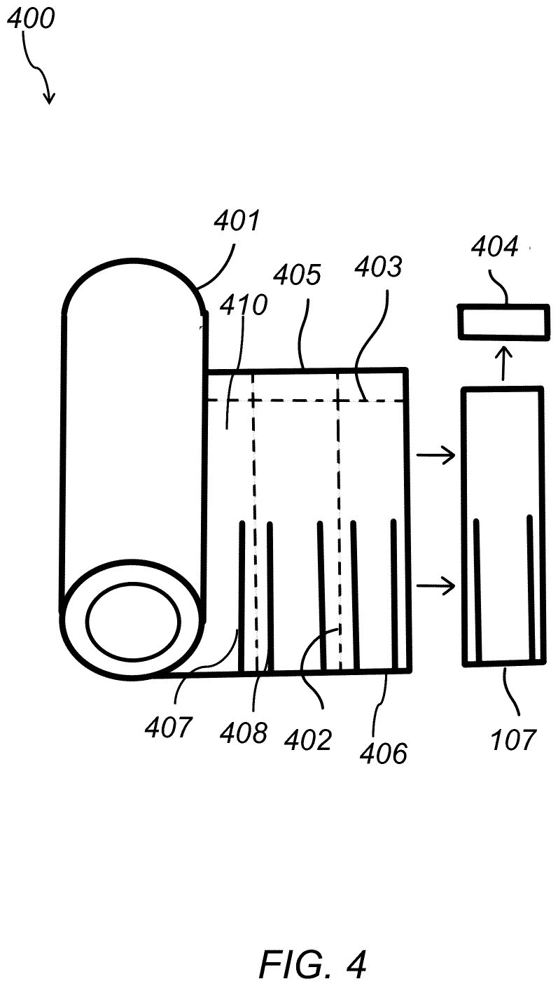

Referring to FIG. 4, in one embodiment of this invention, a plurality of sleeves 107 is manufactured and supplied as a set. In this embodiment, the set of sleeves 107 is supplied as a sheet 410 that is rolled up in a roll 401. The individual sleeves 107 in sheet 410 are connected to each other by pre-perforated lines 402. The sheet 410 of sleeves 107 is heat sealed at edge 406 and the individual sleeves 107 are heat sealed at lines 407 and 408. In order to keep the sleeve ties 103a, 103b from folding away, the sheet 410 of sleeves 107 is further heat sealed at edge 405. A removable tab 404 is formed at edge 405 by including a perforation line 403 along the sealed edge 405. To singulate a sleeve 107 prior to use, a unit is pulled away from the sheet roll 401 by tearing at the pre-perforated line 402, and then the sleeve ties 103a, 103b are freed by further separating the sleeve 107 from the excess tab 404 at the perforation line 403.

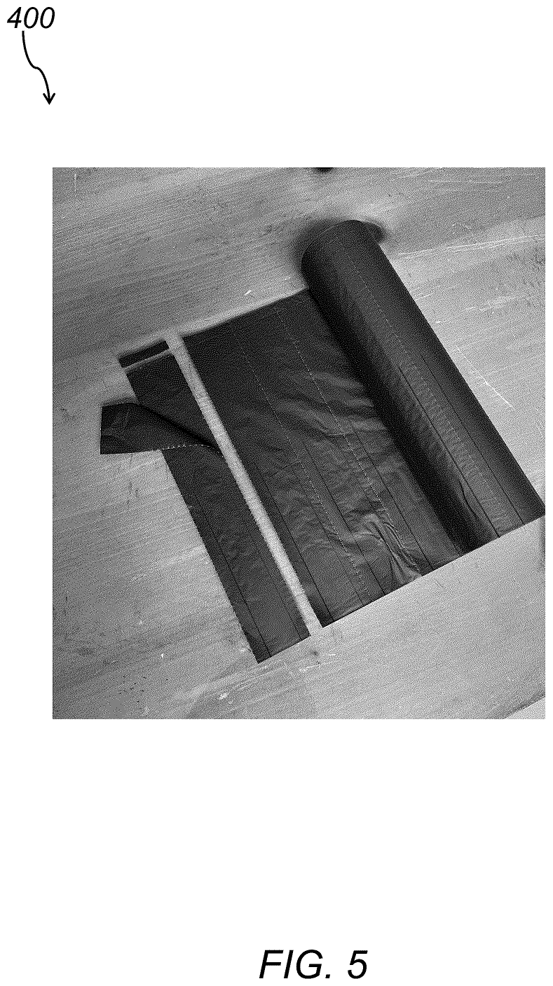

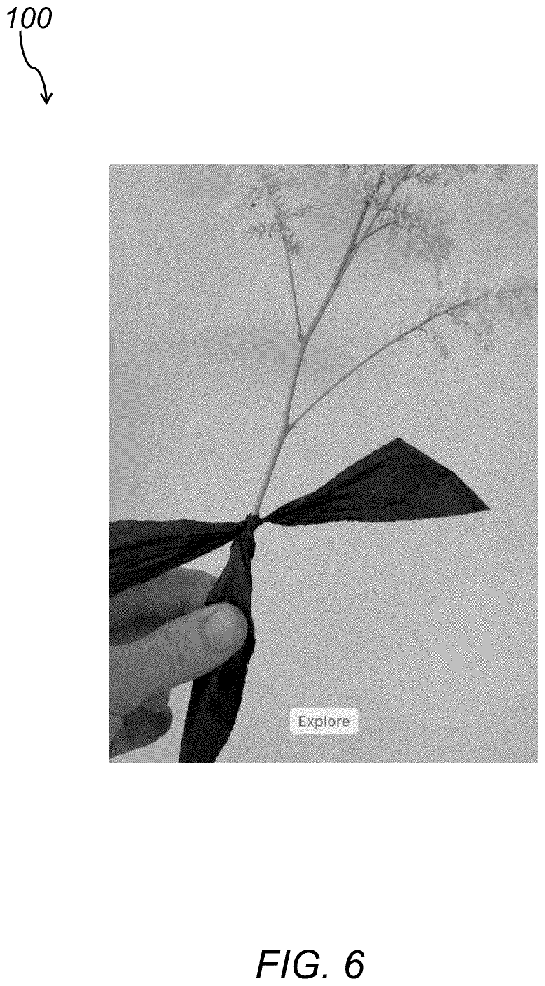

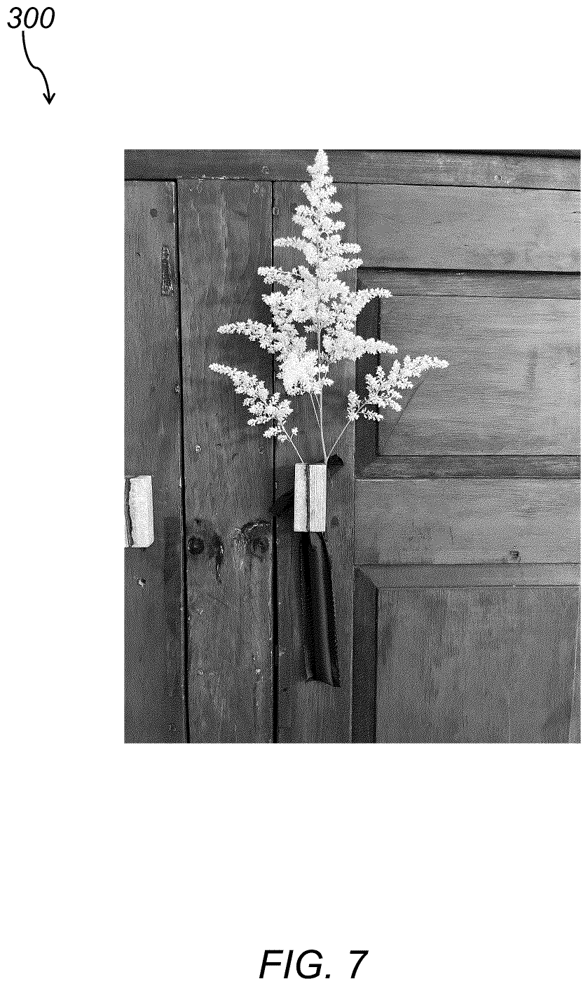

Examples of the water sleeve device 100 with an inserted plant stem are shown in FIG. 6 and FIG. 7. In FIG. 7 the water sleeve device 100 with the inserted plant stem is tied to a door handle for display purposes. An example of a roll form of the water sleeve 100 is shown in FIG. 5. In other embodiments, the water sleeve is filled with a growing medium or with a structural support medium such as foam, coir, gel, or beads.

Several embodiments of the present invention have been described. Nevertheless, it will be understood that various modifications may be made without departing from the spirit and scope of the invention. Accordingly, other embodiments are within the scope of the following claims.

1. A device for hydrating and supporting cut plants comprising:
two or more sheets of flexible film material, shaped and sealed to each other on two opposite sides and a bottom side to form a water sleeve and further comprising an open top side through which a hydrating liquid and cut plants are inserted into the water sleeve;
two or more tie sections extending from the open top side of the two or more sheets of flexible film material, respectively, and wherein the two or more tie sections are configured to be wrapped around one or more stems of the inserted cut plants and knotted, thereby securing the plants, sealing the open top side of the water sleeve, and preventing leakage from the water sleeve.

2. The device of claim 1, wherein remaining free ends of the two or more tie sections are shaped and dimensioned to tie the water sleeve to other plants, or floral mechanics, or vertical structures.

3. The device of claim 1, wherein the two or more sheets of flexible film material are sealable via heat.

4. The device of claim 1, wherein the two or more sheets of flexible film material comprise biodegradable, home compostable materials and are sustainably sourced.

5. The device of claim 1, wherein the two or more sheets of flexible film material comprise a Poly Lactic Acid (PLA) based polymer.

6. The device of claim 1, wherein each of the two or more sheets of flexible film material comprises a film thickness in a range of 5 microns to 1 mm.

7. The device of claim 1, further comprising a growing medium or a structural support medium such as foam, coir, gel, or beads configured to be placed within the water sleeve.

8. A set of water sleeves comprising:
a plurality of water sleeves connected to each other by vertically extending perforated portions;
wherein each of the water sleeves comprises two or more sheets of flexible film material, sealed to each other on two opposite sides and a bottom side, and further comprising an open top side through which a hydrating liquid and cut plants are inserted into the water sleeve;
wherein each of the water sleeves further comprises two or more tie sections extending from the open top side of the two or more sheets of flexible film material, respectively, and wherein the two or more tie sections are configured to be wrapped around one or more stems of the inserted cut plants and knotted, thereby securing the plants, sealing the open top side of each of the water sleeves, and preventing leakage from each of the water sleeves.

9. The set of water sleeves of claim 8, further comprising a longitudinally extending tab connected to the two or more tie sections by a perforated portion.

10. A roll comprising a rolled up set of water sleeves according to claim 8.

11. A method for hydrating and supporting cut plants comprising:
providing two or more sheets of flexible film material, sealing them to each other on two opposite sides and a bottom side to form a water sleeve, and leaving an open top side;
filling the water sleeve with hydrating liquid and inserting cut plants into the water sleeve through the open top side;
wherein two or more tie sections extend from the open top side of the two or more sheets of flexible film material, respectively; and
wherein the method further comprises wrapping the two or more tie sections around one or more stems of the inserted cut plants and knotting them together, thereby securing the plants, sealing the open top side of the water sleeve, and preventing leakage from the water sleeve.

12. The method of claim 11, further comprising tying remaining free ends of the two or more tie sections to other plants, or floral mechanics, or vertical structures.

13. The method of claim 11, wherein the two or more sheets of flexible film material are sealed via heat.

14. The method of claim 11, wherein the two or more sheets of flexible film material comprise biodegradable, home compostable materials and are sustainably sourced.

15. The method of claim 11, wherein the two or more sheets of flexible film material comprise a Poly Lactic Acid (PLA) based polymer.

16. The method of claim 11, wherein each of the two or more sheets of flexible film material comprises a film thickness in a range of 5 microns to 1 mm.

17. The method of claim 11, further comprising filling the water sleeve with a growing medium or with a structural support medium such as foam, coir, gel, or beads.
